(19) United States
(12) Patent Application Publication
(10) Pub. No.: US 2005/0207345 A1
(43) Pub. Date: Sep. 22, 2005

(54) Hybrid ARQ schemes for a multi-carrier communications system

(76) Inventors: Eko N. Onggosanusi, Allen, TX (US); Anand G. Dabak, Plano, TX (US); Timothy M. Schmidl, Dallas, TX (US); Aris Papasakellariou, Dallas, TX (US); Yan Hui, San Diego, CA (US)

Correspondence Address: TEXAS INSTRUMENTS INCORPORATED, P O BOX 655474, M/S 3999, DALLAS, TX, 75265, US

(21) Appl. No.: 11/085,591

(22) Filed: Mar. 21, 2005

Related U.S. Application Data
(60) Provisional application No. 60/555,421, filed on Mar. 22, 2004.

(51) Int. Cl. H04L 12/26

(52) U.S. Cl. 370/236

(57) ABSTRACT

Method for exploiting frequency diversity in a multi-carrier communications system to improve retransmission performance. A preferred embodiment comprises receiving the request for retransmission, formatting data for the retransmission, selecting a carrier from a plurality of carriers, and transmitting the retransmission on the selected carrier. The selected carrier may be different from a carrier used transmit the damaged transmission, thereby frequency diversity is exploited to change the probability of successful transmission in the retransmission. Alternatively, the retransmission may take place at a later time, to permit changes in the selected carrier to take place and obtain frequency diversity via the changed carrier.

This application claims the benefit of U.S. Provisional Application No. 60/555,421, filed 03/22/2004, entitled “Hybrid ARQ Scheme for 3xEV-DV” which application is hereby incorporated by reference.

### TECHNICAL FIELD

The present invention relates generally to a method for digital communications, and more particularly to a method for exploiting frequency diversity in a multi-carrier communications system to improve retransmission performance.

### BACKGROUND

An automatic retransmission request (ARQ) scheme can be used to facilitate the retransmission of data damaged in transmission by automatically requesting the retransmission of the damaged data. The request for retransmission may be in the form of a negative acknowledgment (NACK) or a specific request for a retransmission. When a transmitter of the damaged data receives the request for retransmission, the transmitter can resend the data.

Another commonly used technique that can be used to improve the data throughput of a communications system is the use of error correcting codes. The use of error correcting codes can permit the correction of data that has been damaged to a certain degree. Since the error in the data can be corrected, it is not necessary to consume valuable communications system bandwidth to request a retransmission and to retransmit the damaged data. It is possible to combine the two techniques together into a hybrid ARQ (HARQ).

A multi-carrier communications system features a plurality of individual carriers and can support one or more modulation types. An advantage of a multi-carrier communications system is that compatibility with legacy communications systems can be maintained while increasing available system data rate for enabled systems. Another advantage of a multi-carrier communications system is that frequency diversity (when transmitting on multiple carriers) can be exploited to improve system data rate as well as improve tolerance to interference.

One disadvantage of the prior art is that neither ARQ nor HARQ techniques have been proposed that will take advantage of frequency diversity present in a multi-carrier communications system to improve performance.

### SUMMARY OF THE INVENTION

These and other problems are generally solved or circumvented, and technical advantages are generally achieved, by preferred embodiments of the present invention which provides a method for exploiting diversity in a multi-carrier communications system to improve retransmission performance.

In accordance with a preferred embodiment of the present invention, a method for retransmitting a damaged transmission in a multi-carrier communications system is provided. The method comprises receiving the request for retransmission, formatting data for the retransmission, selecting a carrier from a plurality of carriers, and transmitting the retransmission on the selected carrier.

In accordance with another preferred embodiment of the present invention, a method for selecting a first carrier for a retransmission in a multi-carrier communications system is provided. The method comprises determining a second carrier used in a transmission requiring retransmission, selecting the first carrier based upon the second carrier used in the transmission, and scheduling the retransmission using the first carrier.

In accordance with another preferred embodiment of the present invention, a method for requesting a retransmission in a multi-carrier communications system is provided. The method comprises receiving a transmission, wherein the transmission is made over at least one carrier, detecting an error in the transmission, sending a retransmit request, decoding a control channel to obtain the identity of a carrier used in a retransmission, and receiving the retransmission.

An advantage of a preferred embodiment of the present invention is that frequency diversity is exploited by making use of the additional carriers available in a multi-carrier communications system to help improve tolerance to interference and hence increase the probability of a successful retransmission.

A further advantage of a preferred embodiment of the present invention is that retransmission using alternate carriers can potentially enable a more rapid retransmission since it is possible to select a carrier with less traffic and therefore reduce the amount of wait time needed before the retransmission can occur.

Yet another advantage of a preferred embodiment of the present invention is that a wide variety of HARQ algorithms, such as Chase combining, which makes use of full packet retransmission with coherent combining at the receiver, along with different types of incremental redundancy, such as with the transmission of error correcting codes, new parity bits, along with systematic bits, can be used.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a frequency band diagram of a frequency allocation of carriers in a multi-carrier communications system;

FIG. 2 is a diagram of a pair of electronic devices communicating over a plurality of carriers;

FIGS. 3a and 3b are diagrams sequences of events of the reception of data at a receiver and transmission of data at a transmitter;

FIGS. 4a and 4b are diagrams of retransmission algorithms making use of frequency diversity to improve retransmission performance, according to a preferred embodiment of the present invention;

FIG. 5 is a diagram of a portion of a transmitter of a multi-carrier communications system that has a capability to retransmit failed transmissions, according to a preferred embodiment of the present invention; and

FIG. 6 is a diagram of a retransmission request algorithm, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a three-carrier multi-carrier communications system, such as 3xEV-DV, which is an extension to a single carrier communications system 1xEV-DV. 1xEV-DV is an evolution of CDMA2000 and supports voice and high-speed data using code-division multiple access (CDMA). The invention may also be applied, however, to multi-carrier communications systems in general, with no limit on the number of carriers, such as NxEV-DV (an N-carrier EV-DV system) and an extension to 1xEV-DO, which is yet another evolution of CDMA2000, which can be termed NxEV-DO system. Furthermore, each carrier in the multi-carrier communications system may use different modulation techniques or they may all use a single modulation technique. For example, an exemplary multi-carrier communications system may have a single carrier using CDMA modulation and remaining carriers using any combination of CDMA and orthogonal frequency division multiplexing (OFDM). In addition to using different modulations, the carriers in an exemplary multi-carrier communications system may make use of different modulation parameters, such as different spreading codes, numbers of tones, and so forth, as well as different modulations.

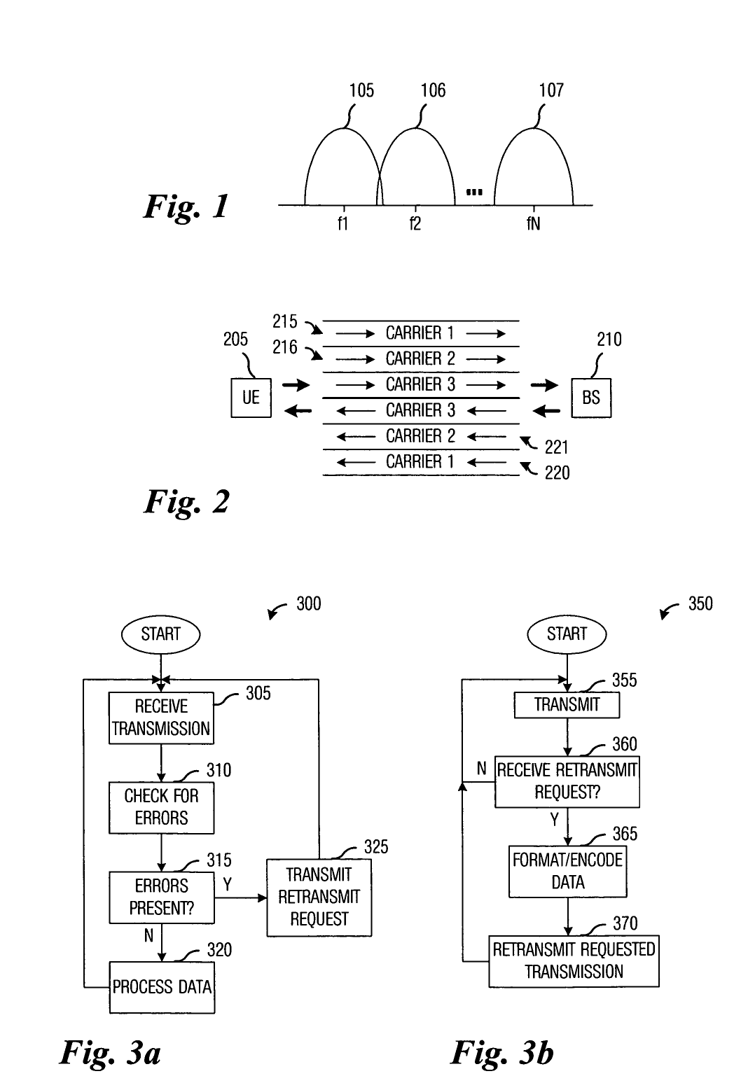

With reference now to FIG. 1, there is shown a frequency band diagram illustrating a frequency allocation of carriers in an exemplary multi-carrier communications system. The exemplary multi-carrier communications system, as shown in FIG. 1, has N carriers, wherein N is an integer number. Each carrier in the exemplary multi-carrier communications system, such as carrier #1 105, carrier #2 106, and carrier #N 107, can span a particular frequency range. Each frequency band can have a center frequency, frequency f1 for carrier #1 105, for example, as well as a certain bandwidth. Each band can have a different bandwidth, the same bandwidth, or combinations thereof. Advantages arising from using multiple carriers rather than a single carrier can include compatibility with legacy systems, the use of different data transmission schemes and modulation schemes in different carriers, the ability to skip certain portions of the spectrum that may already be in use, and so forth.

With reference now to FIG. 2, there is shown a diagram illustrating a pair of electronic devices communicating over a plurality of carriers. As shown in FIG. 2, the pair of electronic devices comprises user equipment (UE) 205 and a base station (BS) 210. However, it can be possible for UE 205 to communicate directly with other UE 205 or for one BS 210 to communicate with another BS 210. When the UE 205 is transmitting to the BS 210, it has several carriers at its disposal, including carrier #1 215 and carrier #2 216. Note that within a single carrier, such as carrier #1 215, there may exist multiple channels. When the BS 210 is transmitting to the UE 205, it can also transmit over a plurality of carriers, such as carrier #1 220 and carrier #2 221.

When an electronic device, such as the UE 205, has data to transmit, the selection of which carrier(s) to use can be dependent upon factors such as carrier and channel quality indicators, current communications network load, data priority, quality of service requirements, and so forth. The carrier selection, transmission prioritization, scheduling, and so on can be made at a transmitter of the electronic device.

Transmissions made over a wireless communications channel can arrive at their destination in a damaged state, even when advanced error correction techniques are being used. When damaged data is received at a receiver, the receiver can request that the data be retransmitted. Data corresponding to the damaged data can be resent when the retransmission request is received. Depending upon the retransmission algorithm used, undamaged data, additional error correction data, and/or combinations of both can be sent.

With reference now to FIG. 3a, there is shown a diagram illustrating an exemplary sequence of events 300 in the reception of data at a receiver. The sequence of events 300 can begin when the receiver begins to receive transmissions from a transmitter (block 305). After receiving the transmission, the receiver can check it for errors (block 310). Note that it may be necessary for the receiver to reconstruct a transmission (a packet) before the error checking can occur. The receiver can use code bits, cyclic redundancy codes, etc. to detect and correct errors that may be present in the transmission. However, there may be instances when the built-in error correction mechanisms cannot fix all of the errors present in the transmission. After checking and correcting errors, the receiver can check to see if the transmission contains errors (block 315).

If the transmission contains no errors, the receiver can process data that is contained in the transmission (block 320) and then return a state ready to receive additional transmissions. If the transmission still contains errors, then the receiver can transmit a retransmit request to the transmitter (block 325). The retransmit request may be in the form of a negative acknowledgment, a specific request to retransmit a transmission, or so forth. After transmitting the retransmit request, the receiver can return to a state ready to receive additional transmissions.

With reference now to FIG. 3b, there is shown a diagram illustrating an exemplary sequence of events 350 in the transmission of data at a transmitter. The sequence of events 350 can begin whenever the transmitter has data to transmit. The transmitter, after properly formatting and coding the data that it wishes to transmit, transmits the formatted and encoded data, referred to as transmission (block 355). As long as there remains data to transmit, the transmitter can continue to transmit. While the transmitter is transmitting, it can also be checking to see if it has received any retransmit requests (block 360). If not, the transmissions can continue.

If a retransmit request has been received, data contained in a transmission that has resulted in the retransmit request can be reformatted and re-encoded, if needed, (block 365) and then retransmitted (block 370). Note that depending upon the implementation, data after transmission may be saved and the reformatting and re-encoding may not need to take place. Alternatively, the data to be retransmitted may be re-encoded using a different (perhaps stronger code) to increase the probability of successful transmission. The retransmission may take place immediately or it may be queued for a later time. After retransmitting (or queuing), the transmitter can return to transmitting any remaining data.

Frequency diversity present in a multi-carrier communications system can be exploited for use in retransmissions. The use of frequency diversity can result in the reduction of the number of retransmissions, thereby reducing the overall transmission latency. For example, a retransmission can take place on a different carrier or the retransmission can be interleaved across multiple carriers. Either technique may provide a measure of frequency diversity and can potentially help retransmission performance. Note that transmission techniques for the initial transmission and retransmissions may either be the same or they may differ. For example, an initial transmission may have a transmission occurring on a single carrier while a retransmission can transmit the same transmission interleaved over multiple carriers. Furthermore, one modulation technique can be used for an initial transmission while a different modulation technique can be used a retransmission.

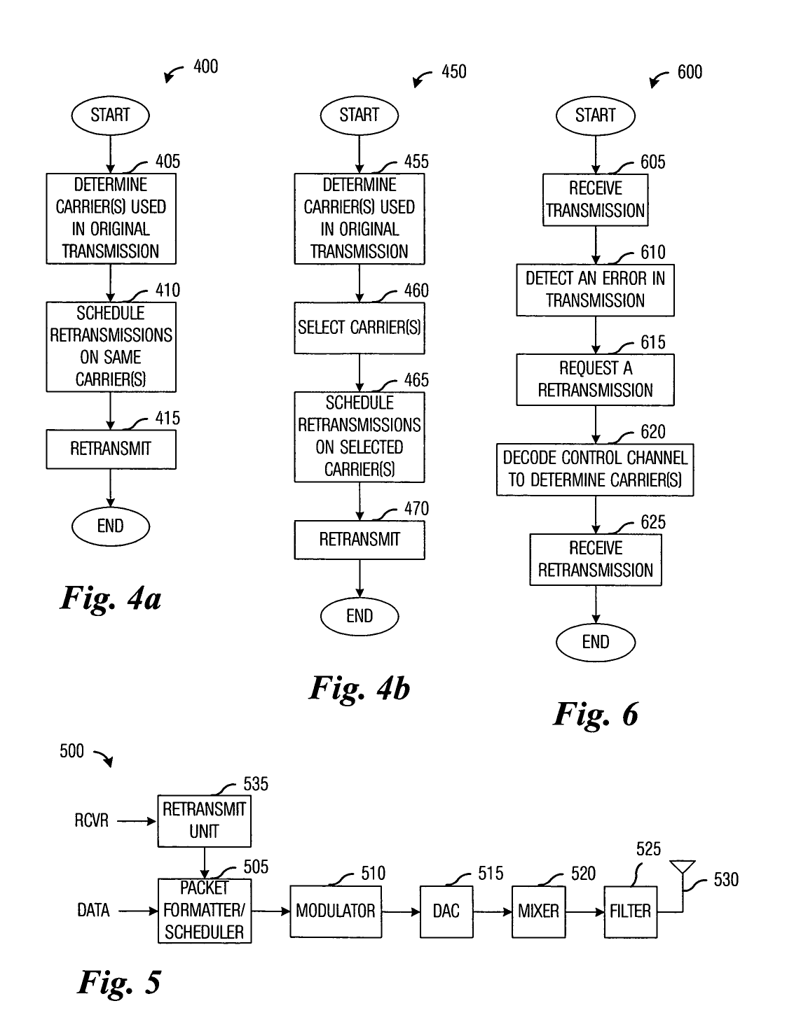

With reference now to FIGS. 4a and 4b, there are shown diagrams illustrating retransmission algorithms that make use of frequency diversity to help improve retransmission performance, according to a preferred embodiment of the present invention. The diagrams shown in FIGS. 4a and 4b illustrate retransmission algorithms that may be exemplary implementations of the retransmit requested transmission block 370 (FIG. 3b). Note that the retransmission algorithms shown in FIGS. 4a and 4b can also be used for subsequent retransmissions. For example, if an initial retransmission also fails, then the retransmission algorithms can be reused for a second (as well as third, fourth, and so on) retransmission attempt.

As discussed previously, the multi-carrier communications system permits the use of frequency diversity available in the multiple frequency bands to improve the probability of successfully retransmitting the transmission. Additionally, the use of alternate carriers can also permit the retransmissions to occur with a smaller latency, hence facilitating faster retransmissions.

The diagram shown in FIG. 4a illustrates a retransmission algorithm 400 that makes use of the same carrier (or set of carriers) used to originally transmit the damaged transmission. After the data to be retransmitted has been formatted and encoded (block 365 (FIG. 3b)), the retransmission algorithm 400 can begin with a determination of the carrier(s) that was used to originally transmit the data (block 405). Note that in some HARQ implementations, rather than retransmit all of the data, incremental data, such as additional error correction information that is needed to correct the errors present in the original transmission, may be transmitted in the retransmission. According to a preferred embodiment of the present invention, this can be accomplished by referencing stored information regarding the original transmission of the data. The transmitter may store information such as the carrier (or set of carriers) it uses for each transmission. Alternatively, a simple fixed algorithm may have been used to allocate the carrier(s). For example, the carrier used for the transmission can simply be based on a time of transmission, an identification number of a recipient of the transmission, an identification number assigned to the data (such as packet number, etc.), and so forth.

Once the carrier(s) have been determined, the retransmission can be scheduled for the same carrier or set of carriers (block 410). Then, at the scheduled time (immediately if the retransmission is to occur as soon as the carrier has been determined), the retransmission takes place (block 415). The retransmission can occur after an arbitrary amount of time, such as a specified number of transmission time intervals (TTIs) or an arbitrary number of TTIs. Also, the TTI value can be kept constant for all retransmissions or it can vary among retransmissions. These values can be varied to address different reliability and/or information load requirements of each retransmission.

The retransmission algorithm 400 can provide good frequency diversity in situations such as when transmissions are scheduled across all users of the multi-carrier communications system and the data for each user is transmitted on all available carriers. Since all available carriers are used, the frequency diversity is available in the original transmission and in the retransmission. Another situation wherein the retransmission algorithm 400 can provide good frequency diversity is when a period of time between the original transmission and the retransmission (or two consecutive retransmissions) is long. Since a large amount of time has elapsed between the original transmission and the retransmission, the nature of the carrier(s) has changed and therefore, the retransmission will not reduce the potential frequency diversity, even if only a single carrier was used for both the original transmission and the retransmission.

The diagram shown in FIG. 4b illustrates a retransmission algorithm 450 that makes use of potentially different carrier(s) than what was originally used to transmit the damaged transmission. After the data to be retransmitted has been formatted and encoded (block 365 (FIG. 3b)), the retransmission algorithm 450 can begin with a determination of the carrier(s) that was used to originally transmit the data (block 455). As discussed previously, information regarding the carrier(s) used can be referenced by accessing stored information pertaining to the original transmission or a simple technique such as time of transmission, destination of transmission, and so forth was used to select carrier(s).

Once the retransmission algorithm 450 has determined the original carrier(s), the retransmission algorithm 450 can select a carrier(s) (block 460). For example, in a three-carrier communications system, if carrier two was used to transmit the original transmission, then the retransmission algorithm 450 can select either carrier one, carrier two, or carrier three. The retransmission algorithm 450 can use carrier quality metrics such as channel quality indicator or traffic metrics to help it select the carrier to use. Note that the selection of the carrier(s) can result in the use of the same carrier(s) used to originally transmit the damaged transmission or a different carrier(s). The same carrier(s) can be used if the carrier(s) is once again the best carrier to handle the retransmission, for example, by using a channel quality metric. The channel quality indicator and/or other traffic metrics can be computed by the electronic device or it may be provided to the electronic device by other electronic devices (such as other electronic devices or by an information server device) in the multi-carrier communications system via an information feedback mechanism, for example.

Not only does the selection of the carrier(s) involve the actual selection of the carriers to be used in the retransmission, the selection of the carrier(s) may also involve the transmission technique to be used. For example, the initial transmission may occur on a single carrier, while the retransmission may use multiple carriers with the transmission being interleaved across the multiple carriers. With the carrier(s) selected (block 460), the retransmission algorithm 450 can schedule the retransmission time (block 465). The retransmission can occur either immediately or at later time, and once the time for the retransmission to take place arrives, the retransmission occurs (block 470).

The retransmission algorithm 450 can provide good frequency diversity in situations such as when transmission scheduling is done in consideration with both the users and available carriers and transmissions from a single user is transmitted across multiple carriers. Another situation wherein the retransmission algorithm 450 can provide good frequency diversity is when a period of time between the original transmission and the retransmission (or two consecutive retransmissions) is short. With a short time between transmission and retransmission, the nature of the carrier(s) has likely not changed significantly; therefore, a retransmission on the same carrier(s) may likely yield the same damaged transmission. Hence, the use of different carrier(s) can provide additional frequency diversity gain. An advantage of using different carrier(s) is that the carrier(s) selected for use in the retransmission can be chosen based on the amount of traffic on the carrier(s). The amount of traffic on a carrier(s) can be an indicator of the amount of time that a transmission may need to wait before it can be transmitted. Therefore, the selection of lightly loaded carrier(s) can mean that the retransmission can occur more quickly. This can reduce the retransmission latency (and the overall communications latency) of the multi-carrier communications system.

Many alternatives exist in the selection of the carrier(s) for retransmission. For example, in a retransmission that involves sufficient data that would require the use of multiple packets, then each packet in the retransmission could be retransmitted using a different carrier. An original transmission involving three packets can be transmitted with packet one on carrier one, packet two on carrier two, and packet three on carrier three. Then, if the transmission must be retransmitted, then on an initial retransmission, packet one can be retransmitted on carrier two, packet two on carrier three, and packet three on carrier one. If another retransmission is required, then packet one can be retransmitted on carrier three, packet two on carrier one, and packet three on carrier two. The automatic cycling of carriers can allow each packet to receive the benefit of frequency diversity without having to interleave the packets across the multiple carriers, which could require more processing overhead.

The selection of the carrier(s) for retransmission may also follow a predetermined (or prespecified) selection pattern. For example, there may be a list that specifies a selection order of carriers already programmed into an electronic device that specifies a sequence of carriers to use for retransmission based upon various criteria, such as retransmission attempt number, priority of retransmission, damaged transmission carrier number, and so forth. An advantage of using a predetermined selection pattern is that processing requirements in making the carrier(s) selection can be reduced as well as minimizing (if not eliminating) a need for computing and transmitting information like channel quality indicators and so forth. The predetermined selection pattern may be provided during an initial power-up sequence when the electronic device attempts to register with a multi-carrier communications system or it may be preprogrammed into the electronic device, for example.

With reference now to FIG. 5, there is shown a diagram illustrating a portion of a transmitter 500 of a multi-carrier communications system, wherein the transmitter has the capability to retransmit failed transmissions, according to a preferred embodiment of the present invention. The diagram of the transmitter 500 illustrates a portion of the transmitter 500 that may be responsible for taking a data stream and performing all necessary operations needed to transmit the data to its intended receiver. A packet formatter/scheduler 505 may be responsible for operations such as taking data from a data stream input and formatting it into proper transmission packets and then scheduling the transmission of the packets on the carrier(s) of choice. In addition to packet formatting and transmission scheduling, the packet formatter/scheduler 505 may also perform carrier(s) selection. For example, it may be specified that a packet be transmitted using two carriers. The packet formatter/scheduler 505 may then select two carriers out of available carriers using metrics such as channel quality, traffic load, measured latency, and so forth.

After packet formatting and scheduling, a modulator 510 can be used to apply the proper modulation needed to enable the transmission of the formatted packet using the selected carrier(s). According to a preferred embodiment of the present invention, the carriers in the multi-carrier communications system may share a common modulation technique or the carriers can be using different modulation techniques. As such, the modulator 510 needs to be capable of applying the different modulation techniques to the formatted packets as needed. After modulation, a digital-to-analog converter (DAC) 515 can be used to convert the modulated signal into its analog representation. A mixer 520 can be used to bring the analog signal to proper frequencies for transmission purposes, while a filter 525 can make sure that the analog signal fits within the frequency characteristics of the carrier(s) being used. Finally, the analog signal is provided to an antenna 530, which broadcasts the signal over-the-air.

A retransmit unit 535, coupled to the packet formatter/scheduler 505 as well as a receiver (not shown) can be responsible for initiating a retransmission. The retransmit unit 535 can receive a retransmit request from the receiver, which may include information such as packet information (packet number, source identifiers, etc.) describing the damaged transmission and based on the retransmit request, the retransmit unit 535 can initiate a retransmission of the damaged transmission. Based upon the retransmission algorithm selected, the retransmit unit 535 may provide the packet formatter/scheduler 505 data contained in the damaged transmission, error correcting bits needed to correct the damaged transmission, or combinations thereof. Additionally, the retransmit unit 535 can provide information regarding the selection of which carrier(s) to use in the retransmission, when to retransmit, and so on.

With reference now to FIG. 6, there is shown a diagram illustrating an algorithm 600 for use in requesting a retransmission of a damaged transmission, according to a preferred embodiment of the present invention. According to a preferred embodiment of the present invention, the algorithm 600 can be used in the detecting of a damaged transmission (or a damaged retransmission) and requesting a retransmission. The algorithm 600 may be used to continually request retransmissions until some limit (such as time or retransmission attempts) has been reached.

The algorithm 600 may begin with a reception of a transmission (or retransmission) (block 605). After a receiver receives a transmission, the receiver will try to ensure that data in the transmission is error free. This can be achieved through the use of error detection and correcting codes applied to the data prior to transmission. The application of the error detection and correcting codes can result in the formation of some error checking data that is transmitted in conjunction with the data. At the receiver, the error checking data can be used to check the data received in the transmission to determine if an error occurred during transmission. If an error occurred, then it may be possible to make use of the error checking data to correct the error. However, if the error is extensive, then it may not be possible to correct the error with the error checking data. If this is the case, then an error has been detected in the transmission (block 610).

The receiver can then send a request to an originator of the transmission to retransmitting data contained in the transmission (block 615). According to an implementation at the originator of the transmission, the data may be retransmitted or additional error checking data may be transmitted. Prior to retransmitting the data (or transmitting additional error checking data), the originator of the transmission may select a carrier(s) to be used. Refer to the discussions of FIGS. 4a and 4b for several retransmission algorithms. Since it may not be possible to know beforehand when the retransmission will take place and over which carrier(s), the receiver will need to decode a control channel to determine the identity of the carrier(s) (block 620). With the identity of the carrier(s) known, the receiver can receive the retransmission (block 625). The reception of the retransmission can then require the receiver to verify the absence of errors in the retransmission. If an error is detected and if it is not correctable, then it may be necessary for the receiver to request another retransmission.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for retransmitting a damaged transmission in a multi-carrier communications system, the method comprising:
receiving the request for retransmission;
formatting data for the retransmission;
selecting a carrier from a plurality of carriers; and
transmitting the retransmission on the selected carrier.

2. The method of claim 1, wherein the data for the retransmission comprises data contained in the damaged transmission.

3. The method of claim 1, wherein the data for the retransmission comprises error correcting data that is used to correct the error in the damaged transmission.

4. The method of claim 1, wherein the selecting comprises:
determining a second carrier used in a transmission requiring retransmission;
selecting the carrier based upon the second carrier used in the transmission; and
scheduling the retransmission using the selected carrier.

5. The method of claim 1, wherein the damaged transmission was transmitted on a third carrier, and wherein the selected carrier is the same as the third carrier.

6. The method of claim 1, wherein the damaged transmission was transmitted on a fourth carrier, and wherein the selected carrier is different from the fourth carrier.

7. The method of claim 1, wherein the selecting is based on one or more of the following: carrier quality, carrier traffic load, carrier transmission wait times, transmission priority, quality of service restrictions, source priority, and destination priority.

8. The method of claim 1, wherein the selected carrier is a plurality of carriers, and wherein the number of carriers in the carrier is less than or equal to a number of carriers in the multi-carrier communications system.

9. The method of claim 1, wherein the selecting is performed following a predetermined selection pattern.

10. The method of claim 1, wherein the selecting is performed using information provided by an electronic device other than an electronic device performing the retransmitting.

11. The method of claim 10, wherein the information conveys channel quality information.

12. The method of claim 1, wherein data contained in the retransmission is identical to data contained in the damaged transmission.

13. The method of claim 1, wherein the damaged transmission contains error correcting information, and wherein the retransmission contains additional error correcting information.

14. The method of claim 1 further comprising prior to the receiving:
at a receiver of the retransmission,
detecting an error in a damaged transmission; and
requesting a retransmission.

15. A method for selecting a first carrier for a retransmission in a multi-carrier communications system, the method comprising:
determining a second carrier used in a transmission requiring retransmission;
selecting the first carrier based upon the second carrier used in the transmission; and
scheduling the retransmission using the first carrier.

16. The method of claim 15, wherein the first carrier is the same as the second carrier used in the transmission.

17. The method of claim 16, wherein the retransmission is scheduled for an amount of time in the future.

18. The method of claim 16, wherein the first carrier used in the transmission is all of the carriers in the multi-carrier communications system, and wherein the retransmission is scheduled to take place as soon as possible.

19. The method of claim 15, wherein the first carrier is also selected using a channel quality indicator.

20. The method of claim 19, wherein the retransmission is scheduled to take place as soon as possible.

21. The method of claim 19, wherein the channel quality indicator is provided by an electronic device not performing the retransmission.

22. The method of claim 15, wherein the second carrier are a plurality of carriers or the first carrier are a plurality of carriers.

23. A method for requesting a retransmission in a multi-carrier communications system, the method comprising:
receiving a transmission, wherein the transmission is made over at least one carrier;
detecting an error in the transmission;
sending a retransmit request;
decoding a control channel to obtain the identity of a carrier used in a retransmission; and
receiving the retransmission.

24. The method of claim 23, wherein the transmission contains error correcting information, and wherein the error is uncorrectable using the error correcting information contained in the transmission.

25. The method of claim 23, wherein the retransmission request is sent via a feedback control channel.

26. The method of claim 23, wherein the transmission is made on a carrier, and wherein the transmission and the retransmission are received on the carrier.

27. The method of claim 23, wherein the retransmission is made over a plurality of carriers.
